(19) United States
(12) Patent Application Publication
(10) Pub. No.: US 2003/0089782 A1
(43) Pub. Date: May 15, 2003

(54) Authenticating textile based items

(76) Inventor: Christopher Reed, Harrogate (GB)

Correspondence Address: MYERS BIGEL SIBLEY & SAJOVEC, PO BOX 37428, RALEIGH, NC, 27627, US

(21) Appl. No.: 10/182,386

(22) PCT Filed: Jan. 29, 2001
(86) PCT No.: PCT/GB01/00341

(30) Foreign Application Priority Data
Jan. 29, 2000 (GB) 001986.9
Jul. 4, 2000 (GB) 0016377.4
Aug. 2, 2000 (GB) 0018848.2
Aug. 16, 2000 (GB) 0020091.5
Dec. 11, 2000 (GB) 0030111.9

(51) Int. Cl. G06K 7/10

(52) U.S. Cl. 235/468

(57) ABSTRACT

A method of producing textile based items whose authenticity is capable of being ascertained includes the application to the item of one or more components which cause an alteration to the response of the item to incident electromagnetic radiation. The one or more components may be arranged in a coded sequence within the item. The invention also provides the item having the one or more components incorporated therein, a method of establishing the authenticity of the item and apparatus associated therewith.

### FIELD OF THE INVENTION

This invention relates to the authentication of garments or other textile based items including fabric. Reference will be made hereinafter mainly to garments but it should be understood that this invention has wider applicability to all forms of textile products. The term “authentication” refers broadly to the establishment that a garment has come from a legitimate source, normally the originator of the garment design or some other party to whom rights to produce the garment have been given.

### BACKGROUND TO THE INVENTION

A serious problem for textile manufacturers is that textile designs are easily copied. By way of example, a large retailer might order from the manufacturer, who owns the rights in a textile design, a number of garments incorporating the design. It is then a simple matter for the retailer to pass one of the garments to another manufacturer who can easily copy the garment including the design and then supply the retailer with further items, often at a lower price. Indeed, the textile item can be so closely copied that the original manufacturer may not be able to distinguish between the genuine item and the copy.

There is a need for a simple and certain method of being able to establish the authenticity of a garment, that is to say, that the garment has been manufactured by the appropriate party and not by a copier.

It is known to apply to a garment in a post-manufacturing procedure a marker, such as a manufacturer's logo or trade mark, the marker being applied by means of a printing process. It is also known to apply labels, by sewing or in some other way, to the manufactured garment. Such “security” measures are easily circumvented by applying the appropriate marker or label to unauthorised copies of the garment.

### STATEMENTS OF THE INVENTION

According to the present invention there is provided a method of producing textile based items whose authenticity is capable of being ascertained, the method comprising applying to structural elements of the textile based item, prior to the manufacture of the item, sufficient of one or more components which cause an alteration to the response of the item to incident electromagnetic radiation.

The term “structural elements” means fibres, yarns or the like which form the body of the textile based item.

Preferably the one or more components are arranged in a coded sequence, an example of which is the well known bar-code, or an equivalent thereof.

Preferably the coded sequence is repeated across at least a portion of the item.

It is preferred that the one or more components are such that electromagnetic radiation outside the visible range is required to elicit the above-mentioned response. The response may be to any suitable electromagnetic radiation, and the or each component may be selected from, for instance, an IR absorber, an IR emitter, a fluorescent material or a UV absorber.

The one or more components may be such that the textile based item requires a treatment subsequent to the manufacture of the item in order to render said components capable of causing said alteration of the response of the item to incident electromagnetic radiation. By way of examples, such post-manufacture treatment may be chemical, heat, or by electromagnetic radiation.

The present invention also provides a textile based item whose authenticity is capable of being ascertained, the item having located on structural elements thereof sufficient of one or more components which alter the response of the item to incident electromagnetic radiation. In other words, the one or more components are typically applied to the fibres, yarns and the like which form the body of the textile based item before the item is manufactured.

In addition, the present invention provides a method of establishing the authenticity of a textile based item according to the invention, the method comprising causing electromagnetic radiation to be incident on at least that part of the item where the or each component is (are) supposed to be located and ascertaining whether the response to said electromagnetic radiation is indicative of that for an authentic item.

Furthermore, the present invention provides apparatus for establishing the authenticity of a textile based item of the invention, the apparatus comprising means for scanning the item with electromagnetic radiation, means receptive to radiation transmitted or reflected by said item as a result of said scanning and means for displaying data indicative of the presence and/or arrangement in the item of said one or more components.

The scanning means may be any suitable instrument, for example, a microscope, a camera or a spectrophotometer. An example of the latter is a Fourier Transform Infra-Red (FTIR) spectrophotometer.

Accordingly, the present invention is concerned with the addition of components to a garment, or other textile item, which will alter the character of incident electromagnetic radiation in a manner different from the character of electromagnetic radiation which is incident on a garment not including such added components. The characteristic of the electromagnetic radiation which is altered may be, for instance, its reflectance or its absorbance.

Any components added to a garment may be a material which is sensitive to a narrow band width of radiation so that it reflects or otherwise responds to incident electromagnetic radiation at one or more specific wavelengths within a specific wavelength range.

As indicated above, in one embodiment of the present invention one or more components may be incorporated into the garment which will, in response to scanning by appropriate equipment, live a sign al corresponding to a predetermined coded sequence. This is similar to the use of the well knows bar-code system used on articles to indicate price, origin and, or other relevant information.

As also indicated above, the term “textile based item” is intended to cover all forms of textile products including, for example, fibres, yarns, fabric (woven and non-woven) as well as to items, including garments, manufactured from any such material.

### DETAILED DESCRIPTION OF THE INVENTION

The invention will now be further described including reference to non-limiting examples and with further reference to the accompanying drawings which consist of FIGS. 1 to 6.

The component(s) which may be incorporated into the garment may be any suitable material(s) which has (have) an appropriate effect on incident electromagnetic radiation. Examples of appropriate effects are fluorescence, phosphorescence, photochromism, halochromism or simply colouration.

Examples of suitable materials are IR, UV and visible light absorbing materials. Specific materials include the following:

2-[2-(2-chloro-3-[2-[1,3-dihydro-1,3,3-trimethyl-2H-1-indol-2-ylidene)-ethylidene]-1-cyclohexen-1-yl]ethenyl]-1,3,3-trimethyl-3H-indolium perchlorate,

1-ethyl-4-[7-(1-ethyl-4(1H)-quinolinylidene)-1,3,5-heptatrienyl]quinoloium iodide;

bis(dithiobenzil)nickel;

1′,3′-dihydro-1′,3′,3′-trimethyl-6-nitrospiro[2H-1-benzopyran-2,2′-[2H] indole; and

2-[2-[2-chloro-3-[2-(3-ethyl-3H-benzthiazol-2-ylidene)-ethylidene]-1-cyclohexen-1-yl]ethenyl-3-ethyl benzthiazolium perchlorate.

Preferably, a component to be incorporated is applied to a particular portion of the textile and, in the case of fabrics, preferably to particular yarns within the fabric. Such a component may be incorporated into the fibres or yarns during their manufacture. Alternatively the component may be applied to the fibres or yarns subsequent to their manufacture.

For instance, the yarns may be made from polyester fibre which is, in turn, manufactured from raw polyester. The raw polyester may be formed into “chips” (known as “POY”), the component added and the chips extruded to form staple or filament polyester fibre. The fibre is then converted into yarn by the process of “spinning” and may be further processed by means of, for instance, air jet apparatus to form “texturised” polyester yarn.

The yarns are then made up into a fabric or other textile structure by, for instance, weaving, knitting or some other process. The resultant textile structure may be printed, dyed or otherwise processed and formed into the final textile item, such as a garment, which will carry the yarns to which the one or more components have been added.

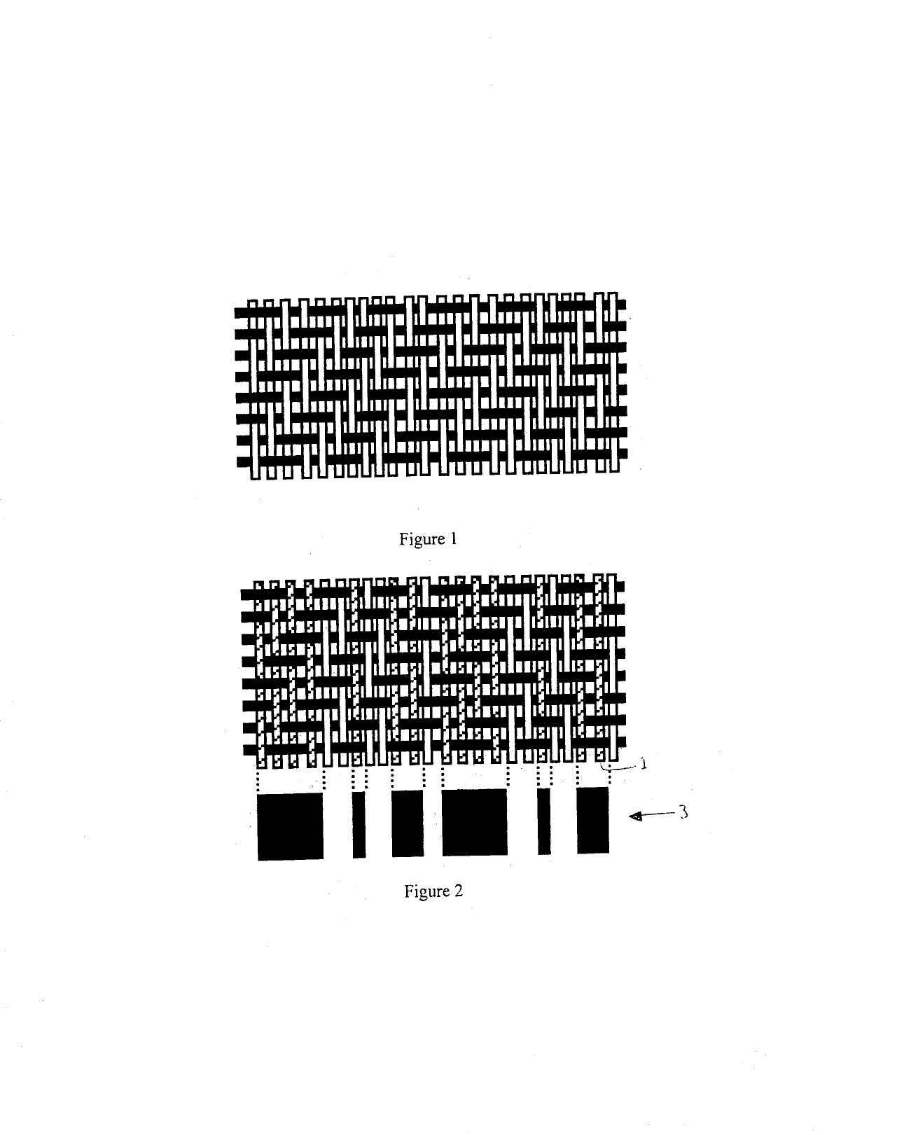

FIG. 1 of the accompanying drawings illustrates a 2/2 twill woven fabric showing both the intersecting warp and weft yarns. FIG. 2 of the accompanying drawings shows a similar woven fabric construction in which certain yarns 1 include an added component. FIG. 2 also shows the resultant “bar-code” 3 produced by scanning the fabric with appropriate electromagnetic radiation. In the fabric shown in FIG. 2 the bar-code repeats over a series of twelve warp threads (those yarns running in the vertical direction in FIG. 2), two full repeats of the bar-code being shown.

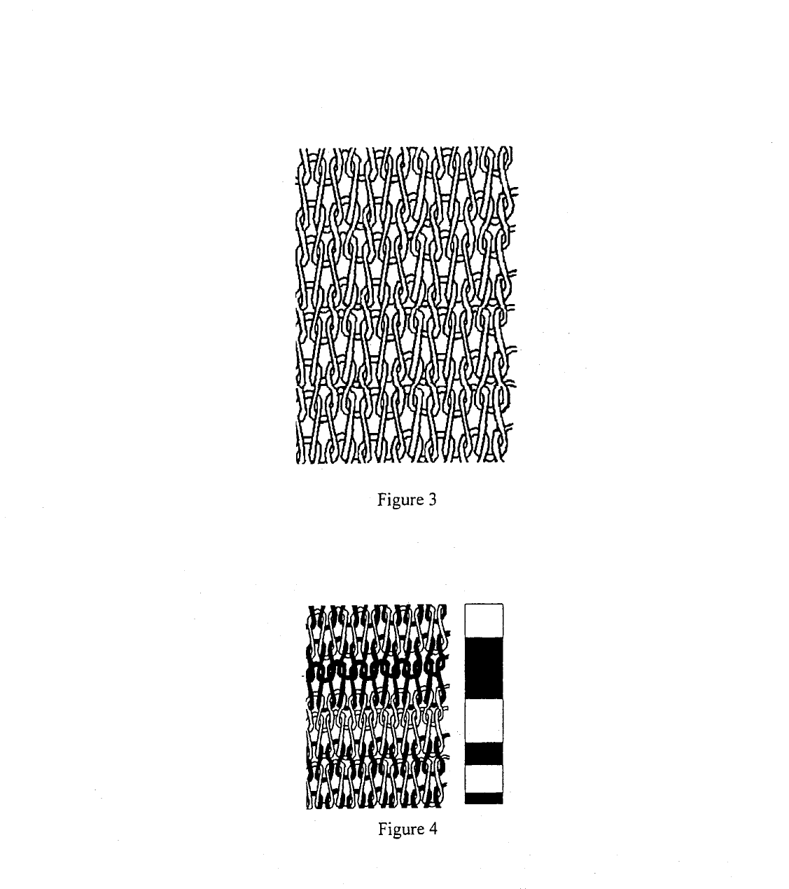

FIG. 3 of the accompanying drawings illustrates a plain weft knitted fabric where the interlinking between the loops of successive yarns can be seen. FIG. 4 of the accompanying drawings shows a similar fabric but with the dark yarns 5 having incorporated therein the added component. The resultant “bar-code” 7 is also shown in FIG. 4.

The number of possible “codes” is limited only by the textile constructions, for example, the number of feeds on a knitting machine or the number of yarns in the warp section of a woven fabric. In woven fabrics, use can also be made of the weft yarns in creating codes and, indeed, both the warp and the weft yarns may be used.

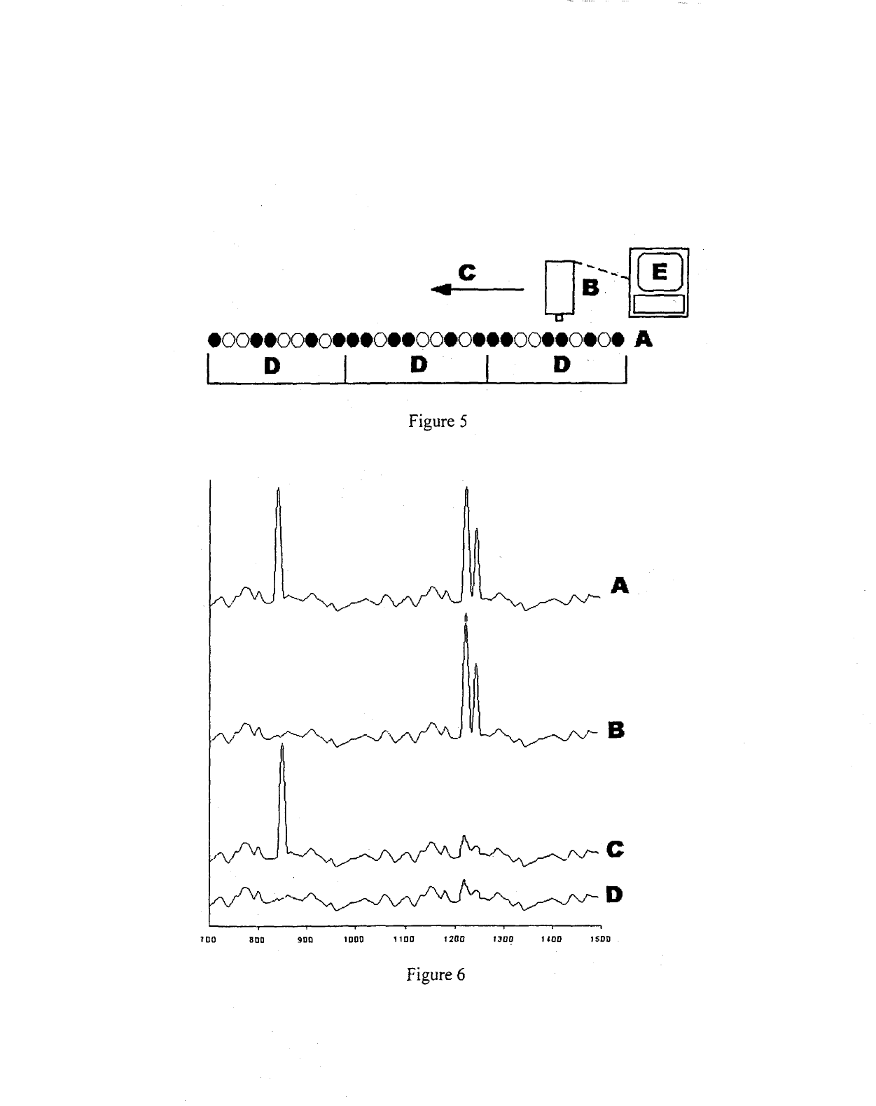

In order to establish whether a garment is a genuine one, an appropriate device is used for causing electromagnetic radiation to be incident upon the garment and for measuring the property or characteristic of the resultant radiation, for instance, its reflectance or absorbance. An example of such device is an infra-red spectrophotometer. The use of such an instrument will now be described in connection with a particular embodiment of the invention in which one or more components are arranged in the garment in a coded manner, in particular, in a manner analogous to a bar-code. Accordingly, the scanning apparatus, which is illustrated in FIG. 5 of the accompanying drawings, may be arranged in a manner similar to that used at the point of sale in retail outlets to read the bar-codes on products being sold.

Referring to FIG. 5, there is shown a cross-section of a textile product A with the bar-code within the yarns being indicated, three repeats, indicated by D, being represented in FIG. 5. The apparatus includes a scanner head B which is movable in direction C relative to the fabric A. Scanner head B relays information to a computer E, or other analysis system, which decodes the scanner information and verifies the authenticity of the textile item.

FIG. 6 of the accompanying drawings illustrates infra-red spectra obtained from scanned yarns, the x-axis representing the wavelength of the radiation and the y-axis the absorbance. Spectrum A is obtained from a yarn including two added components, one having a characteristic peak at a wavelength of 840 nm and the second component having a characteristic dual peak at 1220 nm and 1240 nm.

Spectrum B is for a similar yarn but with the first component omitted. Spectrum C shows again the same yarn but with the second component omitted and Spectrum D is for the same yarn without either component being present.

The detection of the inclusion of one or more components in successive measurements within the garment produces the bar-code and comparison with the known and genuine data for an authentic garment provides the means of authentication.

It should be appreciated that the bar-code incorporated in the garment may indicate various types of information including, for instance, the date and time of manufacture of the fabric, the product owner and the manufacturer. Any garment can be readily checked to see if it carries the information which is appropriate for the genuine articles. The codes may be changed frequently and, as a result, it is impossible for a would-be copier to know which bar-codes to apply to a batch of garments, even if he were able to incorporate appropriate components into the yarns which he uses.

In another embodiment of the present invention, textile material, for instance, woven or knitted fabric, is treated in bulk after the formation of the textile or as part of secondary or subsequent treatment of the fabric (known as “finishing”). In such post-formation treatments, the textile has applied to it sufficient of one or more components so as to cause the alteration of the response of the textile to incident electromagnetic radiation. The or each component may be applied in such a way as to result in the inclusion of the component in the textile so as to give a response to incident electromagnetic radiation which is characteristic of the presence of the component at specific points within the textile. Accordingly, the presence of the component in the appropriate sequence is the indicator of the authenticity of the textile or of the resultant textile item.

The added component may or may not have an immediate effect on instant electromagnetic radiation. It may become detectable at a time subsequent to that at which the component was first applied. Some form of secondary treatment may be used to render the component detectable to appropriate radiation. The various steps in such a procedure may be as follows:—

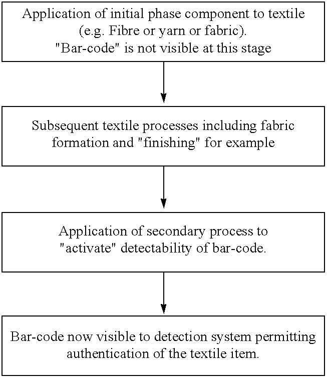

The component within the fabric may be “activated” by various treatments, according to the nature of the fabric. Examples are electromagnetic radiation (ultra-violet, visible or infra-red), or treatment by chemical and/or heat. The effect on incident electromagnetic radiation may therefore only be detected after this subsequent treatment in order that the authenticity of the textile item may be verified. By way of example the component incorporated in the yarns may be trithiocyanuric acid and the textile product may be subjected to after treatment with 7-fluor-nitro-benzoxa-1,3-diazole in order to render the component visible to appropriate radiation. In a further example, the incorporated material is 2-2-naphthol and the secondary treatment is with 4-nitrobenzene diazonium chloride.

1. A method of producing textile based items whose authenticity is capable of being ascertained, the method comprising applying to structural elements of the textile based item, prior to the manufacture of the item, sufficient of one or more components which cause an alteration to the response of the item to incident electromagnetic radiation.

2. A method according to claim 1, wherein the one or more components are arranged in a coded sequence.

3. A method according to claim 1 or claim 2, wherein the coded sequence is in the form of a bar-code or an equivalent thereof.

4. A method according to claim 2 or claim 3, wherein the coded sequence is repeated across at least a portion of the item.

5. A method according to any of the preceding claims, wherein said electromagnetic radiation lies outside the visible range.

6. A method according to any of the preceding claims, wherein the or each component is selected from an IR absorber, an IR emitter, a fluorescent material or a UV absorber.

7. A method according to any of the preceding claims, wherein the textile based item incorporating said one or more components is subjected to treatment subsequent to the manufacture of the item to cause said one or more components to become capable of causing said alteration of the response of the item to incident electromagnetic radiation.

8. A method according to claim 7, wherein said treatment is chemical, heat or by electromagnetic radiation.

9. A textile based item whose authenticity is capable of being ascertained, the item having located on structural elements thereof sufficient of one or more components which alter the response of the item to incident electromagnetic radiation.

10. A method of establishing the authenticity of a textile based item according to claim 9, the method comprising causing electromagnetic radiation to be incident on at least that part of the item where the or each component is (are) supposed to be located and ascertaining whether the response to said electromagnetic radiation is indicative of that for an authentic item.

11. Apparatus for establishing the authenticity of a textile based item according to claim 9, the apparatus comprising means for scanning the item with electromagnetic radiation, means receptive to radiation transmitted or reflected by said item as a result of said scanning and means for displaying data indicative of the presence and/or arrangement in the item of said one or more components.
